(19) United States
(12) Patent Application Publication
(10) Pub. No.: US 2002/0103636 A1
(43) Pub. Date: Aug. 1, 2002

(54) Frequency-domain post-filtering voice-activity detector

(76) Inventors: Luke A. Tucker, Sydney (AU); Mark Greig Wildie, Sydney (AU)

Correspondence Address: Avaya Inc., P.O. Box 629, Holmdel, NJ, 07733, US

(21) Appl. No.: 09/770,922

(22) Filed: Jan. 26, 2001

(51) Int. Cl. G10L 21/00

(52) U.S. Cl. 704/205

(57) ABSTRACT

A voice-activity detector (VAD 104) takes (214) a currently-received set and a previously-received set of samples of a time-domain (voice) signal, converts (216) them into a frequency-domain representation of the signal, filters out (218) negative and low (noise) frequencies, weights (220) the energies of frequency bins (ranges) of the remaining frequencies proportionately to their frequencies, and computes (220) the total power of the ranges. It first initializes (226) by determining (304, 306) if power peaks of any of the ranges exceed a first threshold (ceiling 228); if not, it lowers (302) the ceiling and continues initializing, and if so, it ends initializing (308), indicates (334) that voice has been detected, sets (330) the ceiling to the highest peak, and stores (332) the total power as a “smoothed” power. If initialization has ended, it determines (320, 322) if power peaks of any of the ranges exceed a second threshold that is a fraction of the ceiling; if so, it indicates (334) that voice has been detected, sets (330) the ceiling to the highest peak that exceeds the ceiling, and computes (332) a new “smoothed” power as a function of the total power and the current “smoothed” power. If initialization has ended and energy peaks of none of the ranges exceed the second threshold, it determines (340, 342) if a ratio of the total power and the smoothed power exceeds a third threshold; if so, it indicates (344) that voice has been detected, and if not, it indicates (346) that voice has not been detected.

### TECHNICAL FIELD

This invention relates to signal-classification in general and to voice-activity detection in particular.

### BACKGROUND OF THE INVENTION

Voice-activity detection (VAD) is used to detect a voice signal in a signal that has unknown characteristics. Numerous VAD devices are known in the art. They are usually based on the assumption that a voice signal's characteristics conform to a predefined pattern, and therefore compare the unknown signal against this pattern. The types of characteristics that are often used for signal classification include signal power, zero crossings, and statistical features. Because these solutions require assumptions to be made about the signal's expected characteristics, these types of techniques work only when used under restricted conditions that validate the assumptions.

In voice-over-Internet Protocol (VoIP) applications, there are two main concerns with the use of VAD. The first is the real-time constraints that such applications impose. There is a need to run multiple algorithms concurrently, such as voice activity detection, double talk detection, and noise cancellation, as well as the application that makes use of these, on a single processor. The need to effect recognition simultaneously with other algorithms means that extensive calculations must be avoided if the VAD is to have real-time performance. The second concern is the lack of uniform characteristics of equipment that is used to make the voice call. The need to work with any type of microphone and/or speaker/headphone setup that may be used for the call at the far end in any type of noise environment means that the VAD must be able to adapt to any such equipment and environment's characteristics without prior knowledge thereof.

### SUMMARY OF THE INVENTION

The invention is directed to solving these and other problems and meeting these and other needs of the prior art. Generally according to the invention, the voice signal is separated out from the noise signal by transforming the signal to enhance its energy peaks, preferably by converting the unknown signal to the frequency domain, and selecting only higher frequencies for voice-activity detection. By discarding the low frequencies, the noise signal is effectively filtered out. The power peaks and the total power of the higher frequencies are then compared against thresholds to effect voice-activity detection. To improve detection accuracy, energies of the frequencies are weighted directly in relation to the frequencies, thus boosting the effective power of the higher frequencies. For efficiency of computation, the weighting is effected on frequency bins (ranges) of the higher frequencies, as opposed to being effected on individual frequencies, and is effected on each frequency bin by using the frequency bin's index as a multiplier.

Broadly according to the invention, a method comprises receiving a signal that represents information (e.g., a time-domain signal that represents voice), transforming the signal to enhance its characteristics, preferably by converting the signal to a frequency-domain representation of the signal, determining if energy peaks of any frequencies other than low frequencies of the transformed signal (e.g. of the frequency-domain representation) exceed a first threshold, determining if a total energy content of the frequencies other than the low frequencies exceeds a second threshold, and indicating detection of receipt of the information either if the energy peaks of any of the frequencies other than the low frequencies exceed the first threshold or if the total energy content exceeds the second threshold. Preferably, prior to the determining, the energies of the frequencies are weighted directly in relation to the frequencies so that the effective energies of higher frequencies are increased, substantially proportionally to the frequency. Preferably, at least one of the determining steps then becomes determining if (weighted) energy peaks of any of a plurality of frequency ranges other than low-frequency ranges of the frequency-domain representation exceed a first threshold, or determining if a total (weighted) energy content of the plurality of frequency ranges other than the low-frequency ranges exceeds a second threshold, respectively.

A VAD according to the invention detects voice, rather than silence. It adapts to the level of a reference voice amplitude, and by averaging the highest-level amplitude it predicts with high accuracy the points at which voice trails off into noise. Therefore, a noisy microphone does not greatly impact the VAD's ability to detect voice. It also makes possible developing of acoustic echo cancellers for uncontrolled environments, such as for low-end PC-based “softphones”.

While the invention has been characterized in terms of a method, it also encompasses apparatus that performs the method. The apparatus preferably includes an effector—any entity that effects the corresponding step, unlike a means—for each step. The invention further encompasses any computer-readable medium containing instructions which, when executed in a computer, cause the computer to perform the method steps.

These and other advantages and features of the invention will become apparent from the following description of an illustrative embodiment of the invention considered together with the drawing.

### BRIEF DESCRIPTION OF THE DRAWING

FIG. 1 is a block diagram of a communications apparatus that includes an illustrative implementation of the invention;

FIG. 2 is a block diagram of a voice activity detector of the apparatus of FIG. 1; and

FIG. 3 is a functional flow diagram of operations of an initializer and a comparator of the voice activity detector of FIG. 2.

### DETAILED DESCRIPTION

FIG. 1 shows a Voice-over-Internet Protocol (VoIP) communications apparatus. It comprises a user VoIP terminal 101 that is connected to a VoIP communications link 106. Illustratively, terminal 101 is a voice-enabled personal computer and VoIP link 106 is a local area network (LAN). Terminal 101 is equipped with at least one microphone 102 and speaker 103. Devices 102 and 103 can take many forms, such as a telephone handset, a telephone headset, and/or a speakerphone. Terminal 101 receives packets on LAN 106 from a corresponding terminal or another source, disassembles them, converts the digitized samples carried in the packets' payloads into an analog input signal, and sends it to speaker 103. This process is reversed for input from microphone 102 to LAN 106. Terminal 101 is equipped with an acoustic echo canceler that includes a voice activity detector (VAD) 104. The echo canceler is located within the audio component of terminal 101 which deals with packetizing and unpacketizing of voice signals into and from real-time transport protocol (RTP) packets and with communicating with a sound card to allow recording and playback of sound. The echo canceler communicates directly with the sound-card drivers, as it must be invoked prior to any encoding and packetizing of voice. VAD 104 is used to detect voice signal in the packets received from LAN 106.

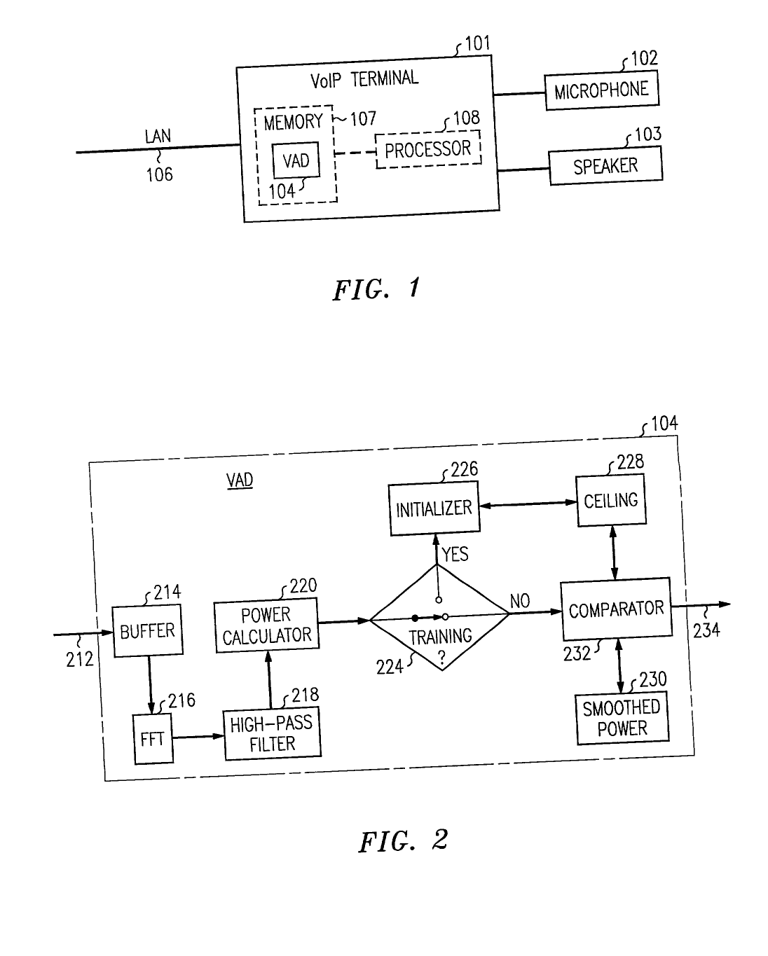

According to the invention, an illustrative embodiment of VAD 104 takes the form shown in FIG. 2. VAD 104 may be implemented in dedicated hardware such as an integrated circuit, in general-purpose hardware such as a digital-signal processor, or in software stored in a memory 107 of terminal 101 and executed on a processor 108 of terminal 101. VAD 104 receives over a link 212 the voice traffic carried by packets over LAN 106 to terminal 101. The received voice traffic represents digital samples of an analog signal taken at an 8 KHz rate. VAD 104 buffers two sets of consecutive samples of the received voice traffic in a buffer 214. These sets can be of any size, but this embodiment illustratively uses sets of 240 samples representing 30 milliseconds of voice signal. VAD 104 feeds the buffered pair of sets to a fast Fourier transform (FFT) 216, discards the first-received set, waits to receive a next set of 240 consecutive samples, and again feeds the buffered pair of sets to FFT 216, ad infinitum.

FFT 216 performs a discrete Fourier transform on each received pair of sets (480 samples) to convert the samples into the frequency domain. Preferably, for efficiency purposes, FFT 216 performs either a radix 2, a radix 4, or a prime-factor radix FFT on the received samples. In FFT 216, the 480 samples in the time domain become 480 bins in the frequency domain, with 240 bins representing negative frequencies and 240 bins representing positive frequencies. As the signals in the time domain are entirely real, the negative frequencies are a duplicate of the positive frequencies and so do not need to be considered. Frequency range per bin is calculated as 4000 Hz/240=16.66 Hz, where 4000 Hz is the frequency ceiling of the sampled signal and 240 is the number of positive frequency bins.

The 240 positive frequency bins (frequency ranges) output by FFT 216 are then high-pass filtered in a filter 218 to filter out sound-card and microphone noise distortion. This distortion mainly occurs at the low frequencies represented by the first ten bins. This noise is filtered out by merely discarding the first ten bins. Since the frequency per bin is 16.66 Hz, the net effect of discarding the first ten bins is to filter the signal with a high-pass filter having a cutoff at 166 Hz. Any significant signal energy that remains after filtering is due to voice. The output of high-pass filter 218 is input to a signal power calculator 220 to calculate the total signal power in bins 11 to 240 by summing the signal amplitude of bins 11-240. The signal power of each bin is also weighted by power calculator 220 to effectively amplify higher-frequency voice components, which normally have lower amplitudes. Illustratively, the weighting involves multiplying each bin's signal power by the bin's index (11-240) before summing over bins 11-240. The weighted power and the total signal power of bins 11-240 is output by calculator 220. Alternatively to using total signal power, VAD 104 may use an average per-bin signal power, obtained by dividing the total signal power by the number of bins (230).

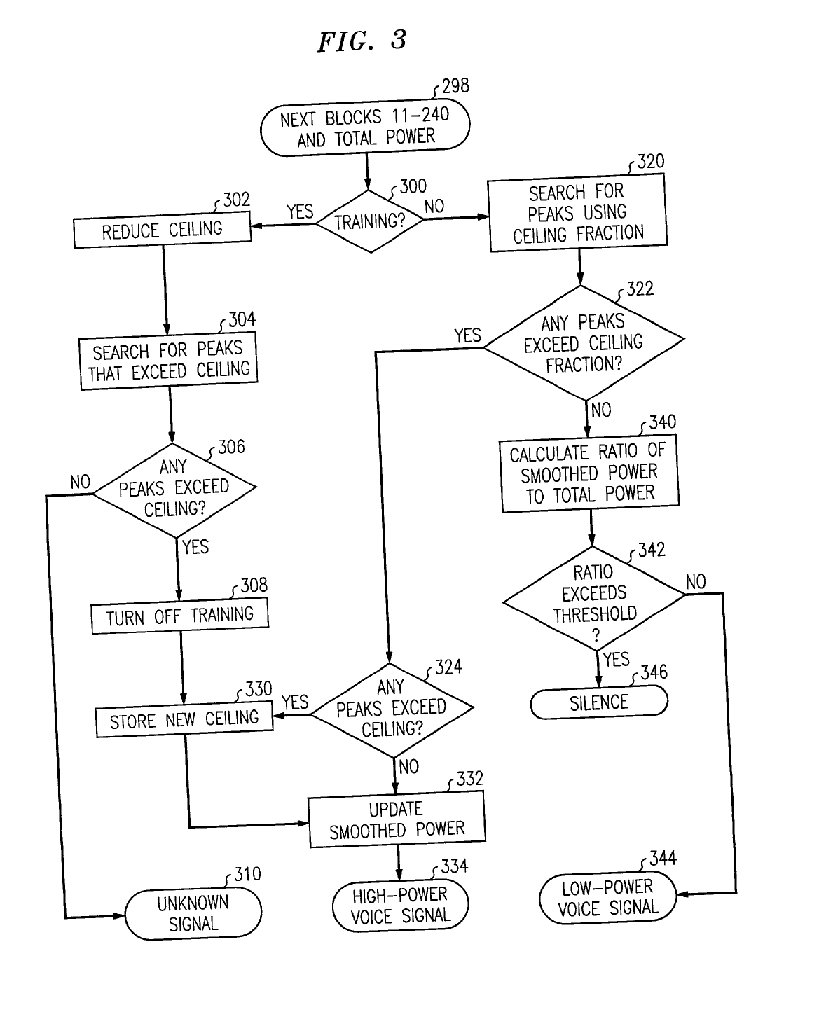

The outputs of filter 218 and calculator 220 are used by the rest of VAD 104 to perform the voice activity detection, which is illustrated in FIG. 3. VAD 104 is adaptive, and must be trained on received signals before it can be used to detect voice activity on that call. If VAD 104 is still in training, as determined at step 300, the current value of a power ceiling (a power threshold) is reduced, at step 302. The assumption is that the ceiling is too high for the signal power of any of the bins to reach it. Therefore, the initial (set by initializer 226 at the start of a call) value of the power ceiling must be set to a value higher than is possible for any voice signal—even a loud voice signal—to have, to ensure that voice will not be falsely detected and that the echo canceler will not converge on the wrong signal (a source of instability if this were allowed to happen). The highest signal peaks of each one of the 230 bins presently supplied, at step 298, by filter 218 is compared against the now-current ceiling 228 to find all bins whose signal power peaks exceed the current value of the ceiling, at step 304. Bins that match this criterion are indicative of high-power voice, such as the middle of a spoken word. If no bins are found whose peak signal power exceeds the ceiling, as determined at step 306, the signal is deemed to be an unknown signal, at step 310, and so VAD 104 remains in the training mode. If any bins are found whose peak signal power exceeds the ceiling, as determined at step 306, voice is deemed to have been detected and VAD 104 is considered to have been trained, and so training 224 is turned off, at step 308, and normal operation begins at step 330.

Returning to step 300, if VAD 104 is determined to no longer be training, the highest signal peak of each bin is compared against the current ceiling 228 to find all bins whose signal power peaks exceed a threshold which is a fraction of the current value of the ceiling, at step 320. While speech varies in power, it is reasonable to expect that peak power will be visible within a power band extending down from the detected ceiling level to some fraction of that ceiling level, experimentally selected in this example as one-tenth of the ceiling level. If any bins are found whose peak signal power meets this criterion, as determined at step 322, these bins are checked against the ceiling to determine if the peak signal power of any of them exceeds the ceiling, at step 324. If so, then a new ceiling corresponding to the highest-found peak signal power is stored as the current ceiling 228, at step 330. Following step 330 or if there are no bins whose peak signal power exceeds the ceiling, a smoothed (long-term average) total signal power 230 is recomputed, at step 332, according to the formula

P′₁=sf·P′₀+(1−sf)P₁

where P′₁ is the new smoothed total signal power, P′₀ is the current smoothed total signal power, P₁ is the current total power output by power calculator 220, and “sf ” is a smoothing factor, typically greater than 0.9, whose experimentally-determined illustrative value in this example is 0.98. The recomputed smoothed total signal power is stored as the new current smoothed total signal power 230. Smoothed signal power is used for accurate determination of low-power voice versus silence at steps 340 et seq. After step 332, an indication is given that a high-power voice signal has been found, at step 334.

Returning to step 322, if no bins are found whose peak signal power exceeds one-tenth of the current ceiling, a ratio of the current smoothed total signal power 230 to current total signal power output by power calculator 220 is computed, at step 340. This ratio is compared against a reasonable lowest threshold value for speech-signal strength. Experiments indicate that a reasonable threshold value is 50, but because VAD 104 is being used to determine whether or not to converge an echo canceler and because false-positive determinations can have dire consequences of misconvergence, the threshold is preferably desensitized, illustratively to a value of 5. If the ratio is less than the threshold value, as determined at step 342, a low-power speech signal is deemed to have been detected, such as the beginning or end of a word, at step 344. If the ratio is more than the threshold value, the energy level in the voice can reasonably be assumed to constitute noise (effectively silence), and so silence is deemed to have been detected, at step 346.

Of course, various changes and modifications to the illustrative embodiments described above will be apparent to those skilled in the art. For example, the voice-activity detection may instead be performed in the time domain, with filters being used to separate the call signal into frequency bands, although this implementation is not favored. Or, the signal may be transformed by using wavelet transforms to enhance detail at certain frequencies. More generally, any transformation can be applied to the signal that results in the prominent features being exposed. Such changes and modifications can be made without departing from the spirit and the scope of the invention and without diminishing its attendant advantages. It is therefore intended that such changes and modifications be covered by the following claims except insofar as limited by the prior art.

What is claimed is:

1. A method comprising:
receiving a signal representing information;
transforming the signal to enhance energy peaks of the signal;
determining if energy peaks of any frequencies other than low frequencies of the transformed signal exceed a first threshold;
in response to determining that the energy peaks of any of the frequencies other than the low frequencies exceed the first threshold, indicating detection of receipt of the information;
determining if a total energy content of the frequencies other than the low frequencies exceeds a second threshold; and
in response to determining that the total energy content exceeds the second threshold, indicating detection of receipt of the information.

2. The method of claim 1 wherein:
transforming comprises
converting the signal to a frequency-domain representation of the signal; and
determining if energy peaks exceed a first threshold comprises
determining if energy peaks of any frequencies other than low frequencies of the frequency-domain representation exceed the first threshold.

3. The method of claim 2 wherein:
converting comprises
weighting energies of the frequencies directly in relation to said frequencies.

4. The method of claim 2 wherein:
determining if energy peaks exceed a first threshold comprises
determining if energy peaks of any of a plurality of frequency ranges other than low-frequency ranges of the frequency-domain representation exceed the first threshold; and
determining if a total energy content exceeds a second threshold comprises
determining if a total energy content of the plurality of frequency ranges other than the low-frequency ranges of the frequency-domain representation exceeds the second threshold.

5. The method of claim 2 wherein:
converting comprises
weighting energies of frequency ranges in the frequency-domain representation directly in relation to frequencies in the frequency ranges.

6. The method of claim 2 wherein:
the signal is a time domain signal.

7. The method of claim 6 wherein:
the information comprises voice.

8. The method of claim 2 wherein:
converting comprises
deleting negative frequencies of the frequency-domain representation.

9. The method of claim 2 wherein:
converting comprises
filtering out low frequencies of the frequency-domain representation.

10. The method of claim 2 further comprising:
determining if the energy peaks of any of the frequencies other than the low frequencies exceed a third threshold,
in response to a training mode of operation and to determining that the energy peaks of none of the frequencies other than the low frequencies exceed the third threshold, lowering the third threshold, and
in response to determining that the energy peaks of any of the frequencies other than the low frequencies exceed the third threshold, ending the training mode; and
determining if energy peaks of any frequencies other than low frequencies exceed a first threshold comprises
in response to a non-training mode of operation, determining if the energy peaks of any of the frequencies other than the low frequencies exceed the first threshold, the first threshold being lower than the third threshold.

11. The method of claim 10 wherein:
ending the training mode comprises
setting an energy peak of the frequencies other than the low frequencies that exceeds the third threshold as the third threshold, the first threshold being a fraction of the third threshold.

12. The method of claim 11 wherein:
determining if a total energy content of the frequencies other than the low frequencies exceeds a second threshold comprises
determining the second threshold as a function of the determined total energy content and any total energy contents determined for priorly-received signals representing information.

13. The method of claim 4 wherein:
determining if a total energy content of the frequencies other than the low frequencies exceeds a second threshold comprises
determining the second threshold as a function of the determined total energy content and any total energy content determined for priorly-received signals representing information.

14. The method of claim 13 wherein:
determining if a total energy content of the frequencies other than the low frequencies exceeds a second threshold further comprises
determining if a ratio of the determined total energy content and the second threshold exceeds a predetermined threshold; and
indicating detection of receipt of the information in response to determining that the total energy content exceeds the second threshold comprises
in response to determining that the ratio of the determined total energy content and the second threshold exceeds the predetermined threshold, indicating the detection of receipt of the information.

15. A method comprising:
receiving a sequence of sets each comprising a plurality of time-domain samples of a signal carrying information;
in response to receiving one of the sets, converting the one set and a previously-received one of the sets to a frequency-domain representation of the signal;
in response to the converting, discarding negative-frequency and low-frequency frequency-domain representation of the signal and dividing remaining said frequency-domain representation of the signal into a plurality of frequency ranges;
weighting energies of the ranges directly in relation to frequencies of said ranges;
determining a total energy content of the remaining frequency-domain representation;
in response to a training mode of operation, determining if energy peaks of any of the ranges exceed a first threshold;
in response to determining that the energy peaks of none of the ranges exceed the first threshold, lowering the first threshold;
in response to the training mode and to determining that the energy peaks of any of the ranges exceed the first threshold, ending the training mode, setting a smoothed power to the total energy content, and indicating detection of the information;
in response to determining that the energy peaks of any of the ranges exceed the first threshold, setting the first threshold to a high one of the energy peaks, determining the smoothed power as a function of the smoothed power and the total energy content, and indicating detection of the information;
in response to ending of the training mode, determining if the energy peaks of any of the ranges exceed a second threshold, the second threshold being a fraction of the first threshold;
in response to determining that the energy peaks of none of the ranges exceed the second threshold, determining if a ratio of the determined total power and the smoothed power exceeds a third threshold;
in response to determining that the ratio exceeds the third threshold, indicating detection of the information; and
in response to determining that the ratio does not exceed the third threshold, indicating a lack of detection of the information.

16. The method of claim 15 wherein:
the information comprises voice.

17. An apparatus that performs the method of one of the claims 1-16.

18. A computer-readable medium containing instructions which, when executed in a computer, cause the computer to perform the method of one of the claims 1-16.
